(19) United States
(12) Patent Application Publication
(10) Pub. No.: US 2026/0060418 A1
(43) Pub. Date: Mar. 5, 2026

(54) FURNITURE FOOT

(71) Applicant: Ashley Furniture Industries, LLC, Arcadia, WI (US)

(72) Inventors: John B. Hawkins, Tupelo, MS (US); Kevin Parrish, Myrtle, MS (US)

(21) Appl. No.: 18/826,002

(22) Filed: Sep. 5, 2024

(51) Int. Cl. A47B 91/00; F16B 3/04; F16B 12/44

(52) U.S. Cl. CPC A47B 91/00; F16B 3/04; F16B 12/44; F16B 2012/446

(57) ABSTRACT

A furniture seat with a plurality of keyed slots on a bottom surface receives a plurality of feet. Each of the plurality of feet having a base portion and a unitary peg. The base portion providing a shape with downward taper to a floor engaging end with the peg extending upwardly from a seat engaging end. The peg of each foot having a key shape to interface with the key slots. The peg having a plurality of spring members unitary therewith that deflect as each peg is inserted into a respective key slot and that then retain the foot to the bottom surface of the furniture seat.

### FIELD OF THE INVENTION

The present invention is generally directed to a toolless foot for attachment to a seat.

### BACKGROUND OF THE INVENTION

Furniture items used for seating commonly comprise a support structure covered by upholstery and/or cushioning. In particular, sofas and chairs typically comprise a seat base, a back rest and a pair of arm rests. Typically, sofas and chairs are fully assembled at the furniture factory by factory workers or machinery to ensure the individual subcomponents are properly assembled and aligned to minimize the appearance of visible gaps or uneven edges in the assembled furniture item.

The inherent drawback of assembling the furniture item at the factory is that typical feet below the seating portion of sofas often prevents efficient packing of the furniture items for transport. Depending on the shape and size of subcomponents of the furniture item, inefficient packing of the furniture item can result in a significant amount of dead space within the shipping container or truck. In addition to increasing the cost of transportation, the dead space can allow the furniture items to shift during transport resulting in damage to the furniture item. Furniture feet, in particular, are prone to breakage during shipment. The use of additional packaging to protect the feet adds to transport costs.

An approach to addressing the drawbacks of factory assembled furniture items includes providing feet separately and requiring users or retailers to install the feet after delivery. This may require tools for securing screws, nuts, bolts, or the like. Consumers who purchase preassembled furniture may not have the experience or ready access to the tools necessary to properly assemble the subcomponents. In some instances, the foot may be askew if it rotates or is not properly aligned then the fastener is tightened. For many pieces of furniture, it may require multiple users to tilt and/or support the piece of furniture while the feet are attached.

Further approaches may include providing individually upholstered subcomponents as a ready to assemble (“RTA”) furniture kit that can be assembled by the end user. Such furniture is often called Knock Down or KD furniture. The individual subcomponents can be more efficiently packed than the fully assembled furniture item and allows the furniture item to be assembled in situ, thereby eliminating the need for navigating the assembled furniture item through the building. As discussed above, an inherent challenge of providing furniture kits, including RTA kits, is that the consumers who assemble the furniture kits are typically unfamiliar with furniture assembly and may not have the experience or ready access to the tools necessary to properly assemble the subcomponents. In addition, manually aligning the often heavy and large subcomponents to install the fasteners for connecting the subcomponents can be difficult, particularly if a single individual is assembling the furniture item. Moreover, as the number of subcomponents assembled together increases, maneuvering the components becomes increasingly challenging as the weight and bulkiness of the assembly increases. A similar concern is that if the fasteners linking the subcomponents are not properly installed, the structural integrity of the furniture item could be compromised resulting in premature failure of the furniture item.

### SUMMARY OF THE INVENTION

The present invention is generally directed to a furniture foot that attaches to a piece of furniture and is retained therewith without the use of tools or separate fasteners. The present invention is further directed to a furniture foot that self-aligns when installed. Improvements in furniture with polymer components making assembly intuitive and simple with the assembled furniture being more robust would be well received by the consuming public. Any other improvements where there are fewer parts and where the components to be assembled, as well as the assembled sofa, would weigh less that current configurations, would be well received by manufacturers and the consuming public. Any improvements where assembly can be performed without the use of tools and separate fasteners would also be well received by manufacturers and the consuming public.

In one aspect, the invention relates to a furniture foot having a base portion and a peg. The base portion has a bottom panel and three wall panels. Each wall panel has a trapezoidal shape with a first base affixed to the bottom panel and a leg affixed to a leg of an adjacent wall panel, such that the three wall panels and bottom panel define a cavity. A second base of each wall panel defines a continuous top edge of the base portion. The peg extends upwardly beyond the top edge of the base portion. The peg has a keyed shape configured to interface with a key slot in a piece of furniture such that the peg can only be inserted into the key slot when properly aligned.

In some embodiments, the keyed shape is a circular with an oblong protrusion. In some embodiments, after insertion, the peg is retained in the key slot by a friction fit. In some embodiments, the peg includes one or more tabs configured to compress upon insertion into the key slot. In some embodiments, the one or more tabs are a spring biased outwards, and the bias generates a force that retains the peg in the key slot upon insertion. In some embodiments, the tab includes a projection that passes through the key slot when compressed, and wherein the projection retains the peg within the key slot once inserted. In some embodiments, the peg further includes a channel aligned with the tab allowing the tab to flex inwardly. In some embodiments, the channel and tab are disposed about a circular portion of the peg. In some embodiments, the cavity comprises a webbing extending between the three wall panels. In some embodiments, the bottom panel comprises a downward facing nub.

In a further aspect, the invention relates to a furniture foot for an upholstered piece of furniture having a key slot on a bottom surface, the furniture foot having a body portion and a key portion. The body portion includes a bottom panel having a perimeter affixed to a bottom edge of a continuous wall panel. The bottom panel and continuous wall panel define an interior cavity. The key portion extends upwardly beyond a top edge of the continuous wall panel. The key portion has a profile conforming to the key slot such that the key portion can only be inserted into the key slot when the key portion and key slot are properly aligned.

In some embodiments, the continuous wall panel is tapered inwardly such that the interior cavity is narrower at the bottom edge of the continuous wall panel than at the top edge of the continuous wall panel. In some embodiments, the continuous wall panel includes a first wall panel, a second wall panel, and a third wall panel such that the body portion has a triangular shape when viewed from the top or the bottom. In some embodiments, the first wall panel and the second wall panel have equal lengths. In some embodiments, the first wall panel and the second wall panel align with outside edges of the upholstered piece of furniture when the key portion is inserted into the key slot. In some embodiments, the key portion is retained within the key slot with a friction fit. In some embodiments, the key portion includes a tab configured to compress when the key portion is inserted into the key slot. In some embodiments, the base portion and the key portion are formed from a polymer. In some embodiments, the base portion and the key portion are injection or blow molded.

In a further aspect, the invention relates to a method of affixing a furniture foot to a piece of upholstered furniture, the method including the steps of providing a piece of upholstered furniture having a key slot on a bottom surface; providing a furniture foot having an upwardly extending key portion; aligning the key portion and the key slot; and inserting the key portion into the key slot until a body portion of the furniture foot is in contact with the bottom surface of the piece of upholstered furniture. In some embodiments, the method further includes repeating the steps of providing a furniture foot, aligning the key portion and the key slot, and inserting the key portion into the key slot until a total of four feet are affixed to the piece of upholstered furniture.

A feature and advantage of embodiments is that the furniture foot may be repeatedly precisely attached in the exact needed location during assembly of the sofa. Such precise location is accomplished during the production of the arm rest panels with key slots drilled with precise locations for receiving the keyed portion of the furniture foot. This configuration eliminates much of the component alignment needed in conventional feet, which are prone to rotating and being out of alignment when screws, bolts, or the like are tightened during assembly. A feature and advantage is a toolless design allowing the foot to be easily attached to a piece of furniture without requiring wrenches, screwdrivers, or the like. The robustly designed key portion of the foot allows for a secure connection when the foot is pushed into the corresponding key slot.

A feature and advantage of embodiments is a furniture foot that is formed of a polymer and having a continuous smooth exposed exterior surface without any sharp corners or rigid projections that are present on wooden or metal feet. Polymer feet may also be lighter and less prone to damage.

The above summary of the various representative embodiments of the invention is not intended to describe each illustrated embodiment or every implementation of the invention. Rather, the embodiments are chosen and described so that others skilled in the art can appreciate and understand the principles and practices of the invention. The figures in the detailed description that follow more particularly exemplify these embodiments.

### BRIEF DESCRIPTION OF THE DRAWINGS

The invention can be completely understood in consideration of the following detailed description of various embodiments of the invention in connection with the accompanying drawings, in which:

FIG. 1 is a front perspective view of a sofa according to an embodiments illustrating a seat base with arm rests, a backrest, and seat cushions.

FIG. 2 is a front perspective view of a wood frame of a seat base connected to a wood frame of the backrest according to embodiments.

FIG. 3 is a bottom plan view of the wood frame of the seat base of FIG. 2.

FIG. 4 is a perspective view of a deboxed RTA sofa in a transport configuration in accord with embodiments.

FIG. 5A is a top perspective view of furniture foot according to embodiments.

FIG. 5B is a bottom perspective view of the furniture foot of FIG. 5A.

FIG. 5C is a cross-sectional view of the furniture foot of FIG. 5A taken along the C-C line.

FIG. 5D is a side view of the furniture foot of FIG. 5A.

FIG. 5E is an enlarged view of the peg portion of the furniture foot of FIG. 5D.

FIG. 5F is a top view of the furniture foot of FIG. 5A.

FIG. 5G is an enlarged view of the peg portion of the furniture foot of FIG. 5F.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

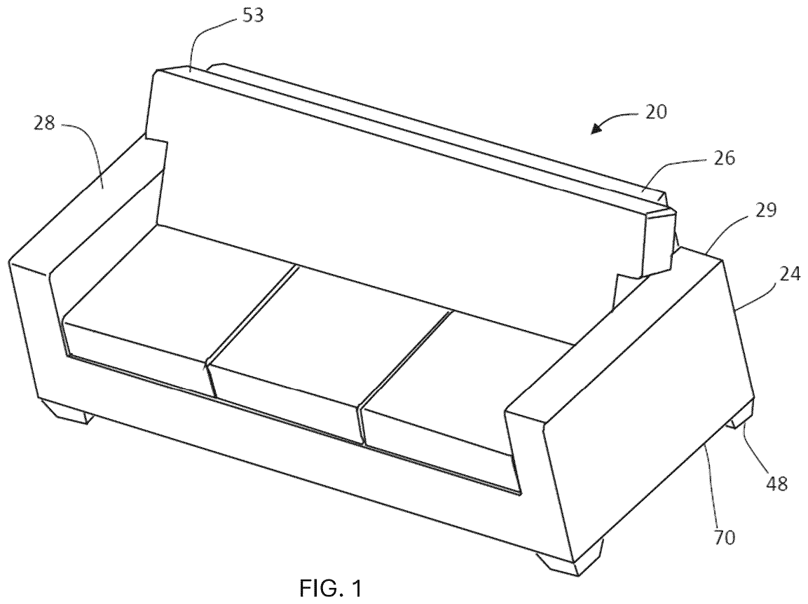

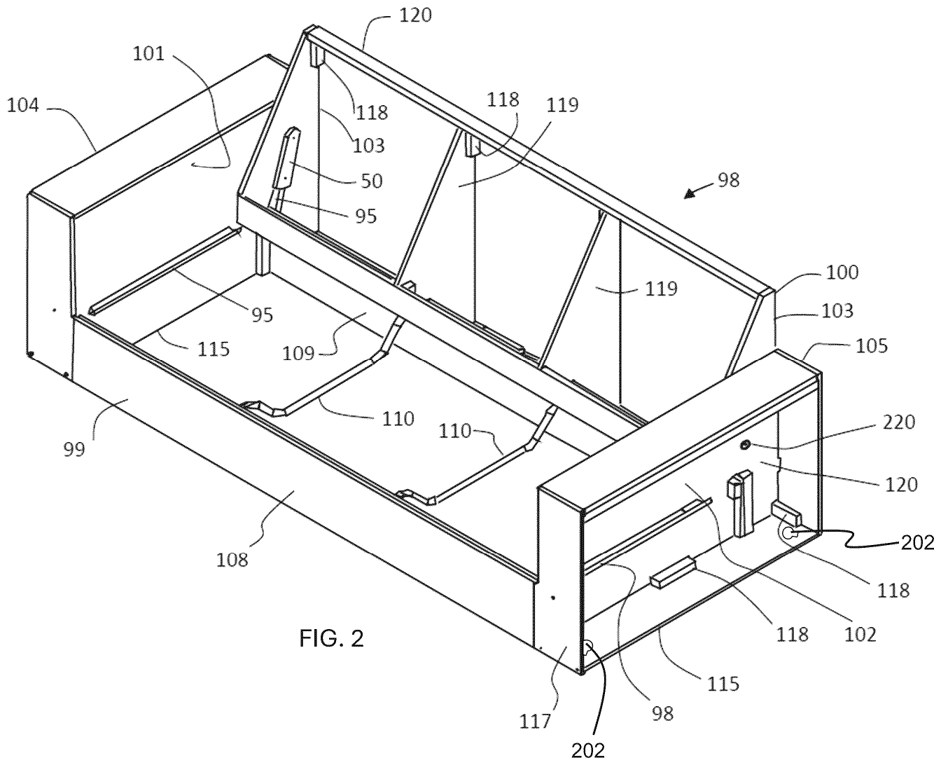

Referring to FIGS. 1-3, components of a sofa 20 for receiving a furniture foot 48 are depicted. The sofa generally comprises a seat base 24 and a backrest 26. The seat base having a pair of integrated arm rests 28, 29 and a seating portion 30 extending therebetween. A forward margin 33 of the seating portion 30 being flush with forward margins 34, 35 of the pair of arm rests. A rearward margin 38 of the seating portion 30 being recessed inward from rearward margins 41, 42 of the arm rests 28, 29. When viewed from the front of or the rear of the seat base, the arm rests and seating portion defining a U-shape. The footprint of the seat base, and the view from above, also define a U-shape. Seat cushions 45, 46, 47 are placeable on the seat base 24 as shown in FIG. 2 with the sofa in the use or assembled configuration. Four feet 48 are attachable to the bottom side of the seat base at four corners 49 of the seat base. In an embodiment of an RTA sofa, a pair of elongate polymer KD brackets 50, 51 are secured to each of the arm rests 28, 29 in an upright orientation with a rearward inclination as best shown in FIG. 1.

The backrest 26, as depicted, may have an attached backrest cushion 53 or a plurality of cushions. In embodiments, the backrest cushion or cushions may be separate or separable or attached as part of the backrest. When viewed from the side, in embodiments, in particular embodiments excluding the backrest cushions as part of the backrest, the backrest may have the shape of a forward inclined 7 when viewed from the right side of the backrest, see FIG. 1, and a mirror image of a forward inclined 7 when viewed from the opposite side, The seat base 24, backrest 26, and cushions 45, 46, 47 may have a general covering material such as upholstery, leather, faux leather, vinyl, or similar material. A seat deck (not shown) is positioned on the top of the seating portion of the seating base and may be comprised of stretchable fabric, or spring supported sheet material, or other combinations. See, for example U.S. Pat. Nos. 9,839,295; 9,420,892; 9,839,295; 10,980,354; and 11,344,135 owned by the owner of this application. Said patents are incorporated by reference herein for all purposes. These patents show options for seat decks that may be suitable for embodiments herein. The slots 95, 98 in the sides of the inward arm rest panels may receive portions of fabric or other material forming the seat deck of the seating portion; see FIG. 2.

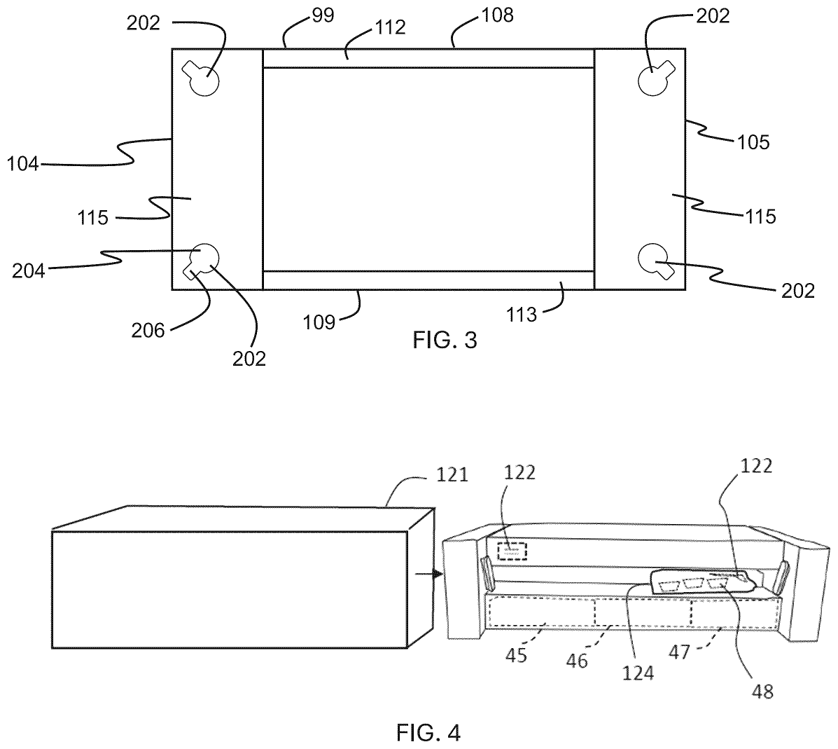

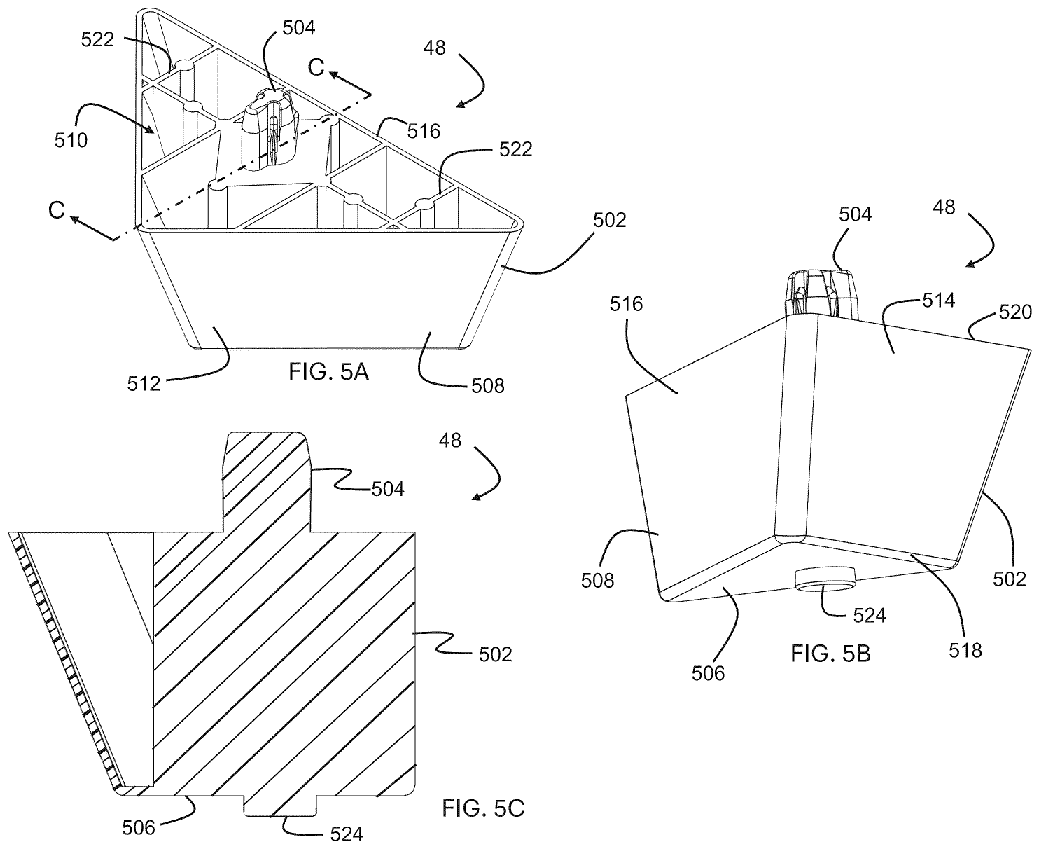

Referring to FIG. 2, an RTA sofa frame 98 comprising a seat base frame 99 and a separable backrest frame 100 as depicted are secured together by the interface between the elongate polymer KD brackets 50, 51, (only one shown in this view) on the inward panels 101, 102 of the arm rest frames 104, 105 and the slots 95 defined in the side panelar frame members 103 of the backrest. The assembled sofa frame as depicted in this configuration for illustrative purposes. In embodiments, the sofa may be a fully preassembled sofa such that the backrest frame is not separable from the seat base frame. In embodiments, the furniture incorporating the invention may be a chair, an ottoman, or other furniture pieces having a frame and feet. In embodiments, the frames are formed from wood boards and/or wood products and may be constructed by conventional well known means. See the patents incorporated by reference in the above paragraph for further details and variations on sofa frame construction. Referring to FIGS. 3 and 4, the seat base frame 99 comprises a pair of arm rest frames 104, 105 with spanning rails 108, 109 extending left and right between the arm rest frames 104, 105 and spring stretchers 110 extending between the spanning rails. The spanning rails comprise a forward base rail 108 and a rearward base rail 109 that support the seat deck 93. Downward facing lower surfaces 112, 113 of the spanning rails are flush with the downward facing lower surfaces 115 of the arm rest frames. In embodiments, the arm rest frames, are rectangular with perimeter frame members 117 and bracing members 118.

The arm rest frames 104, 105 further include key slots 202 through lower surfaces 115 configured to receive a furniture foot 48. In embodiments, the key slots 202 are generally positioned towards an outward corner of the arm rest frame. Key slot 202 has a central opening 204 and a pathway 206 such that a corresponding key (such as a peg on a furniture foot, as described in detail below) may fit through the key slot 202 only when properly aligned. The depicted key slot 202 with a generally circular central opening 204 and oblong or rectangular pathway 206 is provided for illustrative purposes. Other shapes or configurations of a key slot are not beyond the scope of this disclosure.

The backrest frame 100, in embodiments, has a plurality of upright frame members 119 including the side panelar frame members 103, and a plurality of spanning cross members 120 including a breast rail 120.2, an uppermost cross member 120.4 that with upholstery material 89 thereon defines the upper margin 71 of the sofa 20 not including backrest cushions, and that are each attached to each of the plurality of upright frame members and may include wood bracing 118.

In embodiments, portions of the sofa frames may be formed of other materials than wood or wood products. In this regard, see U.S. Pat. Pub. 2022/0071398 owned by the owner of this application and incorporated by reference herein for all purposes.

Referring to FIG. 4, an RTA sofa is shown in the transport configuration with the backrest 26 laying on the seat base 24. The transport configuration is amenable to boxing with box 121. The feet 48 along with instructions 122 and documentation may be included in the boxed sofa in a bag 124. Alternatively, or additionally, assembly instructions 122 may be secured to normally nonvisible locations 126 when in the use configuration, such as the rearward facing surface 128 of the seating portion 30 of the seat base 24, or the inward facing surface 130 of an arm rest 28, 29, or the lower surface 131 of the rearward portion 66 of the backrest 26. Seat cushions 45, 46, 47 and/or backrest cushions 52, 53 may be stowed in the transport mode in various locations. See, for example, U.S. Pat. Nos. 9,474,381 and 9,380,877 for storage options of cushions during shipment of sofas. Said patents are incorporated herein by reference for all purposes. In embodiments, the cushions may be compressed and stored in a sealed bag under vacuum conditions while in the transport configuration for minimizing size.

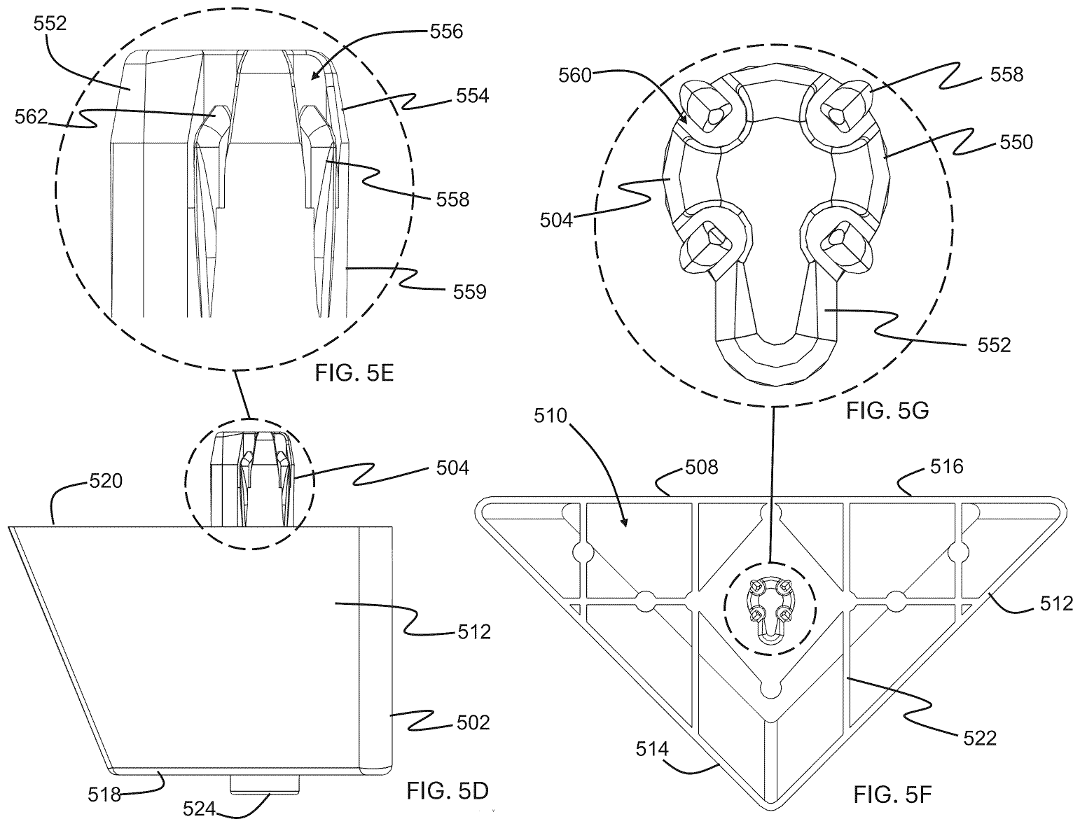

Referring to FIG. 5A-5F, a furniture foot has a body portion 502 and an upwardly extending peg 504 projecting above the body portion 502. In embodiments, the body portion 502 may have a bottom panel 506 and a continuous wall panel 508 defining an interior cavity 510. In embodiments, the continuous wall panel 508 may include various segments or panels. In embodiments, the continuous wall panel 508 may include three wall panels 512, 514, 516 forming a generally triangular shape, as seen in the top view in FIG. 5F. In embodiments, a first and a second side panel 512, 514 may be substantially similar, and a third side panel 516 may be slightly larger than the first and second side panels 512, 514, such that the triangular shape in the top view forms an isosceles triangle. Having similar sides panels 512, 514 facing outward from the furniture presents an appealing aesthetic effect. In embodiments, each panel 512, 514, 516 may have a generally trapezoidal shape with a first base 518 affixed to the bottom panel 506 and a wider base 520 defining a top edge of the body portion 502. Accordingly, the furniture foot 48 may have a slightly inward taper from the top edge towards the bottom panel. Referring to FIGS. 5A and 5F, the body portion 502 may have a plurality of ribs 522 forming a framework or webbing within the cavity 510 and extending between portions of the continuous wall panel 508. The ribs 522 provide structural support to the furniture foot 48, for example, in supporting load from the piece of furniture as well as preventing portions of the wall panel 508 from flexing either inwardly or outwardly. In embodiments, the bottom panel 506 may have a small projection or nub 524. In embodiments, nub 524 may be smoothed or made of an alternate material such that it can protect flooring such as wood floors from scratching or the like.

Referring to FIGS. 5E and 5G, enlarged side and top views of peg 504 are shown. The top view of the peg 504 shows the generally circular post portion 550 and an oblong projection 552 extending outwardly from a side of the post portion 550. The circular post 550 and projection correspond to the central opening 204 and pathway 206 of the key slot 202 such that the furniture foot 48 can only be affixed in a single orientation. As discussed above, the shapes shown are illustrative, and other shapes or arrangements that allow for a single orientation of the components are not beyond the scope of the disclosure.

An upper portion 554 of the post 550 may have recesses or channels 556 disposed about an outer margin of the post. Corresponding tabs 558 may be unitary with a middle section 559 of the post 550 and extend upwardly in the channel 556 such that there is a gap 560 between the tab 558 and the channel 556 allowing the tab 558 to flex inwardly, although, much like a spring, the tab 558 will bias outwards when compressed. An upper portion 562 of the tab 558 be tapered, beveled, or the like, such that upon insertion of the peg 504 into the key slot 202, the tab 558 is compressed into the channel 556. In some embodiments, the peg is retained in the key slot with a friction fit. In some embodiments, the spring like action of the tab creates a tighter friction fit to retain the peg in the key slot. In some embodiments, the tab may have a ledge or hook feature that engages with the key slot, preventing the peg from being removed after it is fully inserted. In embodiments, the peg is sized so that it can penetrate the key slot under the upper margin of the body portion of the foot abuts the piece of furniture.

The furniture foot may be formed of a polymer. In embodiments, the furniture foot may be generally unitary as depicted in the sectional view of FIG. 5C, and formed by injection molding, 3D printing, or the like. In some embodiments, the foot may be formed of multiple materials for example overmolded of different polymers. In embodiments, the body portion may be wooden, and the peg and nub may be polymer. Further, various shapes are not beyond the disclosure. For example, in embodiments, the body portion of the foot may be square, rectangular, circular, or the like. Similarly, although a inwardly tapered foot is shown, in some embodiments the foot may be outwardly tapered, or not tapered at all.

Referring to FIGS. 1 to 5C, the assembly steps affixing a furniture foot 48 to a sofa 20 include aligning the peg and the key slot; and inserting the peg into the key slot until a body portion of the furniture foot is in contact with the bottom surface of the sofa. These steps may be repeated with additional feet until a total of four feet are affixed to the piece of upholstered furniture.

While the invention is amenable to various modifications and alternative forms, specifics thereof have been shown by way of example in the drawings and described in detail. It is understood, however, that the intention is not to limit the invention to the particular embodiments described. On the contrary, the intention is to cover all modifications, equivalents, and alternatives falling within the spirit and scope of the invention as defined by the appended claims.

All the features disclosed in this specification (including the references incorporated by reference, including any accompanying claims, abstract and drawings), and/or all of the steps of any method or process so disclosed, may be combined in any combination, except combinations where at least some of such features and/or steps are mutually exclusive.

Each feature disclosed in this specification (including references incorporated by reference, any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. When “about” is used herein with reference to a parameter, about means within 5% of the stated parameter.

The invention is not restricted to the details of the foregoing embodiment(s). The invention extends to any novel one, or any novel combination, of the features disclosed in this specification (including any incorporated by reference references, any accompanying claims, abstract and drawings), or to any novel one, or any novel combination, of the steps of any method or process so disclosed.

Although specific examples have been illustrated and described herein, it will be appreciated by those of ordinary skill in the art that any arrangement calculated to achieve the same purpose could be substituted for the specific examples shown. This application is intended to cover adaptations or variations of the present subject matter. Therefore, it is intended that the invention be defined by the attached claims and their legal equivalents, as well as the following illustrative aspects. The above described aspects embodiments of the invention are merely descriptive of its principles and are not to be considered limiting. Further modifications of the invention herein disclosed will occur to those skilled in the respective arts and all such modifications are deemed to be within the scope of the invention.

1. A furniture foot comprising:
a base portion having a bottom panel and three wall panels, each wall panel having a trapezoidal shape with a first base affixed to the bottom panel and a leg affixed to a leg of an adjacent wall panel, such that the three wall panels and bottom panel define a cavity and a second base of each wall panel defines a continuous top edge of the base portion; and
a peg extending upwardly beyond the top edge of the base portion, the peg having a keyed shape configured to interface with a key slot in a piece of furniture such that the peg can only be inserted into the key slot when properly aligned.

2. The furniture foot of claim 1, wherein the keyed shape is a circular with an oblong protrusion.

3. The furniture foot of claim 1, wherein, after insertion, the peg is retained in the key slot by a friction fit.

4. The furniture foot of claim 1, wherein the peg comprises a tab configured to compress upon insertion into the key slot, the tap comprising a spring biased outwardly.

5. The furniture foot of claim 4, in combination with a seat and three additional like furniture feet, the seat having four key slots with a respective one of the four feet inserted into each of the four key slots.

6. The combination of claim 5, wherein the tab of each foot comprises a projection that passes through the respective key slot when compressed, and wherein the projection retains the peg within the respective key slot once inserted.

7. The combination of claim 5, wherein the peg of each furniture foot further comprises a channel aligned with the tab allowing the tab to flex inwardly.

8. The combination of claim 7, wherein the channel and tab of each furniture foot are disposed about a circular portion of the respective peg.

9. The furniture foot of claim 1, wherein the cavity comprises a webbing extending between the three wall panels.

10. A plurality of furniture feet attached tor an upholstered piece of furniture having a plurality of key slots on a bottom surface of the upholstered piece of furniture, each of the plurality of furniture feet comprising:
a body portion comprising a bottom panel having a perimeter affixed to a bottom edge of a continuous wall panel, the bottom panel and continuous wall panel defines an interior cavity; and a key portion extending upwardly beyond a top edge of the continuous wall panel, the key portion having a profile conforming to the key slot such that the key portion can only be inserted into the key slot when the key portion can only be inserted into the key slot when the key portion and key slot are properly aligned.

11. The plurality of furniture feet of claim 10, wherein the continuous wall panel of each of the plurality of feet is tapered inwardly in a downward direction such that the interior cavity is narrower at the bottom edge of the continuous wall panel than at the top edge of the continuous wall panel.

12. The plurality of furniture feet of claim 10, wherein the continuous wall panel of each of the plurality of feet comprises a first wall panel, a second wall panel, and a third wall panel such that the body portion has a triangular shape when viewed from the top or the bottom.

13. The plurality of furniture feet of claim 12, wherein the first wall panel and the second wall panel of each of the plurality of furniture feet have equal lengths.

14. The plurality of furniture feet of claim 13, wherein the first wall panel and the second wall panel of each of the plurality of furniture feet align with an outside edge of the upholstered piece of furniture when the key portion is inserted into the key slot.

15. The plurality of furniture feet of claim 12, wherein the key portion of each of the plurality of feet is retained within the respective key slot with a friction fit.

16. The plurality of furniture feet of claim 12, wherein the key portion of each of the plurality of feet comprises a tab configured to compress when the key portion is inserted into the respective key slot.

17. The plurality of furniture feet of claim 12, wherein the base portion and the key portion of each of the plurality of feet are formed from a polymer.

18. The plurality of furniture feet of claim 10, wherein the base portion and the key portion of each of the plurality of feet are injection molded.

19. A method of affixing a plurality of furniture feet to a piece of upholstered furniture seat, the method comprising:
providing the piece of upholstered furniture seat having a plurality of key slots on a bottom surface of the upholstered furniture seat;
providing the plurality of furniture feet each having an upwardly extending key portion;
aligning the key portion of each of the plurality of furniture feet with a respective key slot;
inserting the key portion of each of the plurality of furniture feet into the respective key slots until a body portion of the furniture foot is in contact with the bottom surface of the piece of upholstered furniture.

20. The method of claim 18 further comprising deflecting a spring member on each of the plurality of furniture feet as the furniture foot is inserted into the respective key slot.
